(19) United States
(12) Patent Application Publication
(10) Pub. No.: US 2004/0067416 A1
(43) Pub. Date: Apr. 8, 2004

(54) Protective frame for rechargeable battery cells

(76) Inventor: Gregory K. MacLean, Indianapolis, IN (US)

Correspondence Address: MARGARET A. DOBROWITSKY, DELPHI TECHNOLOGIES, INC., P.O. Box 5052, Mail Code: 480-410-202, Troy, MI, 48007-5052, US

(21) Appl. No.: 10/265,969

(22) Filed: Oct. 7, 2002

(51) Int. Cl. H01M 2/02

(52) U.S. Cl. 429/186; 429/162; 429/185

(57) ABSTRACT

Assembly and techniques for mechanically protecting electrolytic stackable cells are provided. The assembly includes a frame configured to provide a protective barrier relative to predefined outer areas of the stackable cells. A foil sealingly encloses the frame relative to the surrounding environment, wherein the protective barrier avoids contact between the foil and the predefined outer areas of the stackable cell, thereby avoiding damage to the stackable cells along the predefined areas.

### BACKGROUND OF THE INVENTION

Due to their superior electrochemical properties, rechargeable batteries, such as lithium-based batteries, are presently used in a great variety of consumer-related devices, such as laptop computers, telephones, audio-visual devices, etc. For the same reasons, such batteries offer great potential for other applications yet to be fully exploited, such as electric and hybrid electric vehicular applications.

It is known that laminate material (e.g., a foil) may enclose the generally flat, stackable cells that make up the battery. The enclosing foil enables to maintain a vacuum seal relative to the surrounding environment to prevent, for example, ingress of moisture and oxygen into the cell as well as egress of liquid electrolyte, in the event such type of electrolyte is used. However, this type of vacuum-sealed packaging may result in incrementally higher forces (e.g., pressure) acting on some vulnerable areas of the cell stack, e.g., the edges, and corners of the stack. The areas of the cell stacks subject to such higher forces may deform and eventually crush the underlying electrode films, which would result in non-uniform utilization of the active materials and, in turn, could lead to lithium plating and substantial reduction in the life expectancy of the cell. FIG. 1A illustrates an example of an undesirable condition referred to as a “fold over” of an unprotected cell edge. That is, crushing caused by the laminate packaging over the upper most layer of the cell stack. In some extreme cases, electrical shorting can result in the event the underlying separator splits at an edge subject to incremental pressure. FIG. 1B illustrates an example of physical edge damage due to mechanical shock, such as dropping or bumping of the cell against another object.

With the intent of avoiding such undesirable conditions, it is known to sufficiently increase the thickness of the foil so that the foil does not buckle when subjected to the vacuum, and consequently avoid interference with the cell edges. Unfortunately, the incremental thickness of the foil results in higher manufacturing costs and increases the overall weight of the cell. It is also known to introduce foam material within the packaging with the expectation that such foam may somehow provide a protective barrier relative to the cells. However, the introduction of foam is generally time consuming and somewhat messy, and consequently neither of these attempts has been fully satisfactory to avoid the foregoing undesirable conditions.

In view of the foregoing considerations, it would be desirable to provide a protecting frame specifically configured to protect the edges and corners of the cell stack so as to prevent the vacuum-sealed foil (e.g., a relatively thin foil or poach) from crushing these sensitive areas. It would be further desirable to provide a frame that may be reliably and affordably produced so as to allow suppliers (e.g., suppliers of automotive components) to effectively compete in the marketplace. It would also be desirable to provide a protecting frame that may be effectively utilized with a thin foil so as to retain the benefits of such thin foil while avoiding vacuum-induced forces along the edges and corners of the cell stack. In addition, it would be desirable to protect the edges and corners of the cell stack from damage that could occur due to mechanical shock of the cell, such as may occur during drops, bumps, knocks, etc.

### BRIEF SUMMARY OF THE INVENTION

Generally, the present invention fulfills the foregoing needs by providing in one aspect thereof, an assembly for electrolytic stackable cells. The assembly includes a frame configured to provide a protective barrier relative to predefined outer areas of the stackable cells. A foil sealingly encloses the frame relative to the surrounding environment. In this manner, the protective barrier avoids contact between the foil and the predefined outer areas of the stackable cell, thereby avoiding damage to the stackable cells along the predefined areas.

In another aspect thereof, the present invention further fulfills the foregoing needs by providing a method for assembling an electrolytic cell and a protective assembly. The method allows providing a first electrolytic cell within the assembly. The method further allows configuring a frame to provide a protective barrier relative to predefined outer areas of the cell. The frame may be mounted onto respective ones of the predefined outer areas of the cell. The frame is sealingly enclosed relative to the surrounding environment with a foil, wherein the protective barrier avoids contact between the foil and the predefined outer areas of the cell, thereby avoiding damage to the cell along the predefined areas due to forces that otherwise may act thereon including vacuum-induced forces.

### BRIEF DESCRIPTION OF THE DRAWINGS

The features and advantages of the present invention will become apparent from the following detailed description of the invention when read with the accompanying drawings in which:

FIG. 1A illustrates an example of an undesirable condition referred to as a “fold over” condition that, prior to the teachings of the present invention, could arise in an unprotected edge of electrolytic stackable cells.

FIG. 1B illustrates an example of another undesirable condition, such as may occur when the unprotected edge of the cell is hit by another object.

FIG. 2 is an isometric view of an exemplary frame configured to provide a protective barrier relative to predefined outer areas of stackable cells with terminals extending mutually opposite from one another.

FIG. 3 is a top view of one exemplary embodiment wherein the frame of FIG. 2 is made up of two separate sections.

FIG. 4 is, in part, a cross-sectional view along line 4-4 of the frame of FIG. 3.

FIG. 5 is an isometric view of a protecting assembly for electrolytic cells including a protective frame and a foil for sealingly enclosing the frame and cells relative to the surrounding environment.

FIG. 6 is an isometric view of an exemplary frame configured to provide a protective barrier relative to predefined outer areas of stackable cells with terminals positioned on the same side of the cells.

FIG. 7 is a top view of one exemplary embodiment wherein the frame of FIG. 5 is made up of two separate sections.

FIG. 8 illustrates details regarding the frame of FIG. 6, and, in particular, of an exemplary slit that allows passage to the terminals that share a common side of the cell stack.

FIG. 9 is an isometric view of another exemplary frame made up of two separate sections, wherein a first one of the sections may be used to provide a base support to a plurality of cells being stacked on to one another, and a second one of the sections is mounted onto the cell stack upon completion of the cell stack.

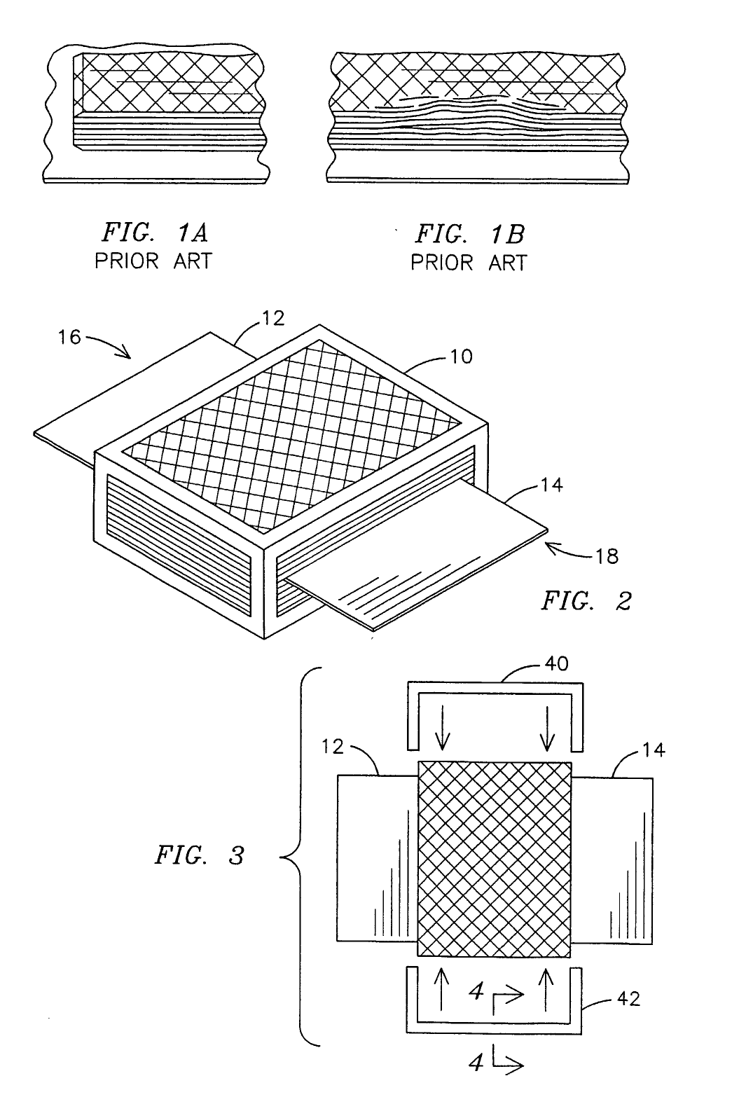

### DETAILED DESCRIPTION OF THE INVENTION

The inventor of the present invention has innovatively recognized a protective frame configured to protect the edges and corners of rechargeable electrolytic stackable cells that otherwise could be crushed if exposed to forces that may develop during operational and environmental conditions of the cell. One example of such forces may be pressure-induced forces in a vacuum-sealed foil. Other examples may be forces due to unintended mechanical shock to the cell, such as may occur during drops, bumps, knocks. The foil may be a flexible foil or poach made of a relatively thin laminate material, such as aluminum, copper or any other material that has good impermeability properties relative to moisture and oxygen, for example. In one exemplary embodiment, the thickness of the foil may be approximately 0.012 to 0.051 millimeters (12 to 51 microns). As will be appreciated by those skilled in the art, keeping the thickness of the foil relatively thin is advantageous since this would allow providing a flexible packaging at a relatively low cost. Thus, one desirable feature enabled in accordance with aspects of the present invention is the ability to provide a thin foil packaging while mechanically protecting sensitive areas of the stackable cells. It will be appreciated, however, that even embodiments using a much thicker foil could benefit from using a protective frame, as contemplated by the present invention, to provide edge protection against mechanical shock, e.g., drops and bumps.

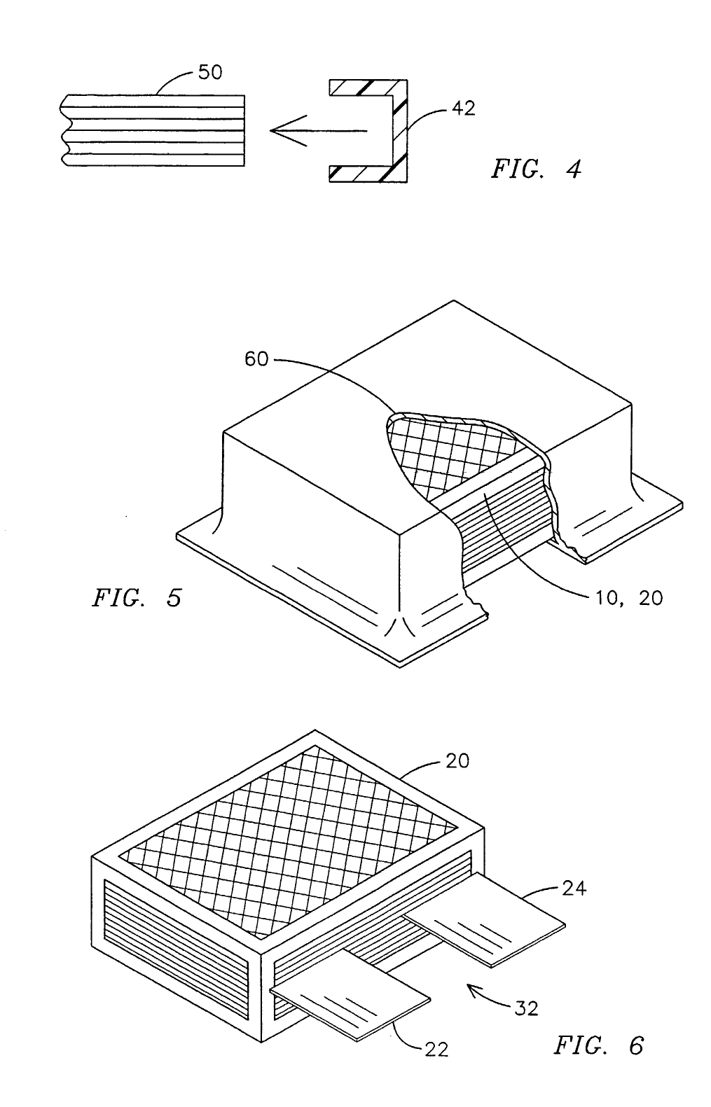

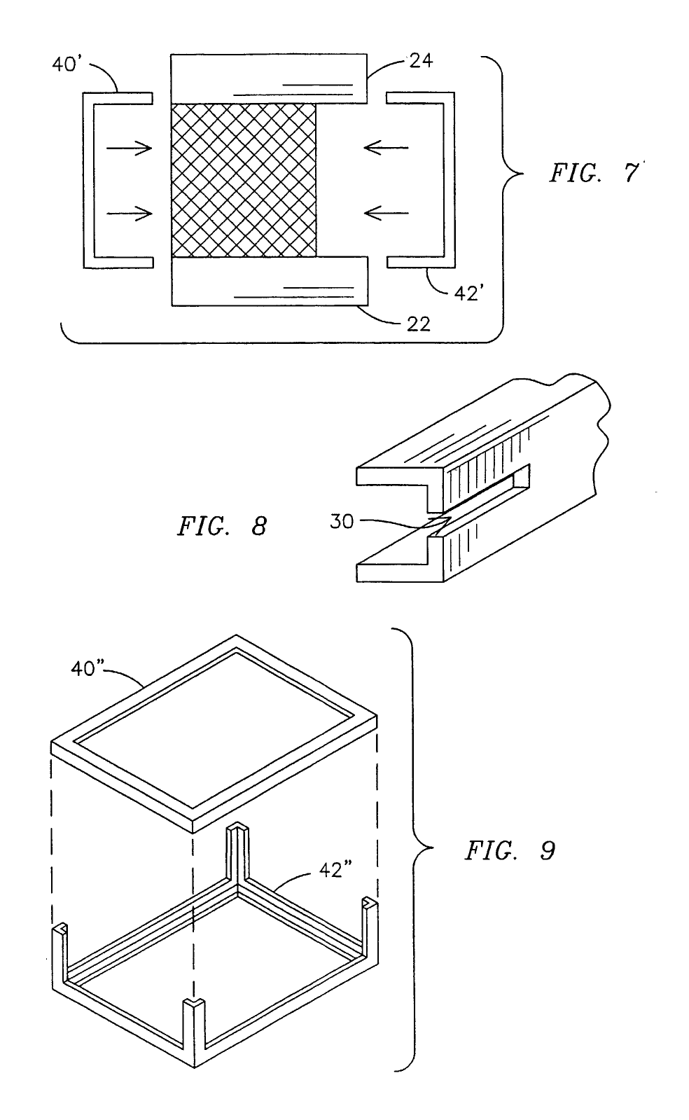

FIG. 2 is an isometric view of an exemplary frame 10 configured to provide a protective barrier relative to predefined outer areas of the stackable cells. In one exemplary embodiment, the outer areas that are specifically protected by the protective barrier include the edges and corners of the stackable cell. As shown in FIG. 2, in one exemplary embodiment, frame 10 may be configured to define at least two open sides (e.g., sides 16 and 18) for enabling passage to a pair of terminals 12 and 14 extending from the stackable cells mutually opposite relative to one another. In another exemplary embodiment, a frame 20 (FIG. 6) includes a pair of slits (e.g., slit 30 (FIG. 7)) for enabling passage to a pair of terminals 22 and 24 extending relative to a common side (e.g., side 32) of the stackable cells.

The protective frame may be constructed from any material (e.g., plastic) that is light yet exhibits relatively high strength and is electrochemically inert. Examples of some materials that would be suitable for use in constructing a light, strong cell-protecting frame may be: polyolefins (i.e. polyethylene or polypropylene), polyacrylic acid esters, polyacetates, cellulose acetate and butyrate, nylons, polycarbonates, polyterephthalates, polystyrenes, polyacrylonitriles, polytetrafluoroethylene, polyfluorochloroethylenes, polyvinylchloride, polyvinylchloride acetate, and copolymers and mixtures thereof. It would be understood that the foregoing list is merely illustrative and should not be construed as limiting the invention.

As exemplarily shown in FIGS. 3, 7 and 9, the frame may be made up of at least two sections (e.g., sections 40 and 42) separately mountable onto respective ones of the predefined areas of the rechargeable cells, e.g., stackable cells 50 (FIG. 4). As will be appreciated by those skilled in the art, the shape and construction of the protective frame may be varied to meet the form and fit requirements of any given application, such as the size and construction of the cell and positioning of its terminal tabs. For example, the protective frame may be constructed as a unitary piece that protects each edge and corner of the cell stack, or it may be made up of two or more separate sections that are configured to protect some areas of the cell stack. The frame sections may be made in any number of ways well understood by those skilled in the art, such as injection molding, milling, machining, etc. The corners and edges of the cell support frame can have, but need not have, a curved radius to prevent tearing of the laminate packaging material.

As suggested above, the protective frames respectively illustrated in FIGS. 3, 7 and 9 illustrate some examples of these many variations. For example, in the frame illustrated in FIG. 9, the stackable cells may be mounted onto section 42 before section 40 is mounted over the top of the cells. Another variation relative to the protective frame shown in FIG. 9, may be to similarly provide a section that acts as a base, e.g., section 42, except that in lieu of providing a top section 40, a lateral section (not shown) would be the last section to be mounted onto the cells. Yet another variation would be to provide multiple pieces that may be individually assembled relative to each edge and corner of the cell stack.

The frame sections may be constructed to be joined together and onto the cell by any of various joining techniques, such as snapping, gluing, fusing, solvent-bonding. If a chemical adhesive is used for achieving the joining of the sections, care should be exercised to choose an adhesive that is inert relative to the electrolyte. That is, an adhesive that would not dissolve or degrade or otherwise induce a chemical reaction with the electrolyte.

The completed cell stack can either be slipped inside the partially open protective frame, after which the last section of the frame is attached, or the frame can be assembled around the completed cell stack. In another exemplary embodiment, the base and at least one side of the protecting frame can be used to locate and align relative to one another the plurality of cells that make up a cell stack. Once the cell stack is completed, any remaining sections of the protecting frame would be assembled onto the completed stack.

As illustrated in FIG. 5, the laminate packaging material (e.g., foil 60) would be wrapped and sealed around the protective frame including the cell stack. In one exemplary embodiment, foil 60 sealingly encloses the frame relative to the surrounding environment, with the protective frame or barrier avoiding contact between the predefined outer areas of the stackable cells and thus avoiding damage to the stackable cells along the predefined areas. If desired, the packaging material may be bonded (via heat or adhesive) to the protective frame.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. An assembly for electrolytic stackable cells, the assembly comprising:
a frame configured to provide a protective barrier relative to predefined outer areas of the stackable cells; and
a foil sealingly enclosing the frame relative to the surrounding environment, wherein the protective barrier avoids contact between the foil and the predefined outer areas of the stackable cell, thereby avoiding damage to the stackable cells along the predefined areas.

2. The assembly of claim 1 wherein the frame comprises at least one edge protector.

3. The assembly of claim 1 wherein the frame comprises at least one corner protector.

4. The assembly of claim 1 wherein the frame comprises at least two sections separately mountable onto respective ones of the predefined areas of the stackable cells.

5. The assembly of claim 1 wherein the frame defines at least two open sides for enabling passage to a pair of terminals extending from the stackable cells mutually opposite relative to one another.

6. The assembly of claim 1 wherein the frame includes a pair of slits for enabling passage to a pair of terminals extending relative to a common side of the stackable cells.

7. An electrolytic cell with a protecting assembly, comprising:
at least one electrolytic cell within the assembly;
a frame configured to provide a protective barrier relative to predefined outer areas of the cell; and
a foil sealingly enclosing the frame relative to the surrounding environment, wherein the protective barrier avoids contact between the foil and the predefined outer areas of the cell, thereby avoiding damage to the cell along the predefined areas due to forces that otherwise may act thereon including vacuum-induced forces.

8. The electrolytic cell of claim 7 wherein the frame comprises at least one edge protector.

9. The electrolytic cell of claim 7 wherein the frame comprises at least one corner protector.

10. The electrolytic cell of claim 7 wherein the frame comprises at least two sections separately mountable onto respective ones of the predefined areas of the cell.

11. The electrolytic cell of claim 7 wherein the frame defines at least two open sides for enabling passage to a pair of terminals extending mutually opposite relative to opposite sides of the cell.

12. The electrolytic cell of claim 7 wherein the frame includes a pair of slits for enabling passage to a pair of terminals extending relative to a common side of the cell.

13. A method for assembling an electrolytic cell and a protective assembly, the method comprising:
providing a first electrolytic cell within the assembly;
configuring a frame to provide a protective barrier relative to predefined outer areas of the cell;
mounting the frame onto respective ones of the predefined outer areas of the cell; and
sealingly enclosing the frame relative to the surrounding environment with a foil, wherein the protective barrier avoids contact between the foil and the predefined outer areas of the cell, thereby avoiding damage to the cell along the predefined areas due to forces that otherwise may act thereon including vacuum-induced forces.

14. The assembly method of claim 13 wherein the configuring of the frame further comprises configuring at least two sections separately mountable onto respective ones of the predefined areas of the cell.

15. The assembly method of claim 14 wherein the mounting of the frame comprises mounting a first one of the two frame sections onto a first one of the predefined areas of the cell.

16. The assembly method of claim 15 further comprising stacking additional electrolytic cells relative to the first cell, and aligning each electrolytic cell relative to one another using the first frame section.

17. The assembly method of claim 16 further comprising, upon completion of the stacking and aligning of the cells and prior to the sealing step, mounting the second of the two frame sections onto the remainder of the predefined areas of each cell.

18. The assembly method of claim 14 further comprising stacking additional electrolytic cells relative to the first cell.

19. The assembly method of claim 18 further comprising, upon completion of the stacking of the cells and prior to the sealing step, mounting a first one of the two frame sections onto a first one of the predefined areas of the cell, and mounting the second of the two frame sections onto the remainder of the predefined areas of each cell.
